(19) United States
(12) Patent Application Publication
(10) Pub. No.: US 2005/0147949 A1
(43) Pub. Date: Jul. 7, 2005

(54) Method and system for reducing accident occurrences

(76) Inventor: Larry Wilson, Whistler (CA)

Correspondence Address: HAYES, SOLOWAY P.C., 130 W. CUSHING STREET, TUCSON, AZ, 85701, US

(21) Appl. No.: 10/749,572

(22) Filed: Dec. 31, 2003

(51) Int. Cl. G09B 19/00

(52) U.S. Cl. 434/219

(57) ABSTRACT

The present invention relates generally to accident prevention, and more specifically, to a method of, and system for training individuals which reduces the frequency and/or severity of accident occurrences. The invention provides a method of reducing the frequency of industrial accidents comprising the steps of: determining the mental state of an individual at the time of an accident or close call; classifying the cause of the accident as being due to the individual being in one of four hazardous mental states; identifying the state-to-error risk pattern; and teaching the individual to effect critical error reduction techniques, to avoid future occurrences of accidents. The invention also provides a checklist outlining this methodology, for use in accident investigation.

The present invention relates generally to accident prevention, and more specifically, to a method of, and system for training individuals which reduces the frequency and/or severity of accident occurrences.

### BACKGROUND OF THE INVENTION

In most industrialized nations, health and safety regulations have been legislated in an effort to reduce the frequency and severity of accidents in the workplace. Typically, these regulations impose duties on employers and other parties who have some degree of control over the workplace, the materials and equipment in use, and the activities of the employees. Generally, it is required that employers take all reasonable precautions to protect the health and safety of their employees. Regulations may also set out specific responsibilities with regard to toxic substances, hazardous machinery, worker education, health and safety committees, safety supervisors, and personal protective equipment.

Apart from satisfying the regulatory duty, there is also a practical and economic benefit to operating a safe workplace. A safe workplace results in good employee morale, higher productivity, less lost time due to injury and absenteeism, and lower insurance costs.

Because of the regulatory requirements and economic benefits, there is a huge demand for systems and methodologies which effectively reduce the frequency of occurrence of accidents, and when accidents do occur, to reduce the severity of those accidents. Many systems and methodologies have been proposed, but none have been highly effective. The two most commonly used are behaviour based safety (BBS), and accident analysis.

The BBS process starts with a Pareto Analysis of about five years of incident investigation data in a given environment to identify behaviours (or factors) that contributed to between 85 and 95 percent of the accidents which occurred. A Pareto Analysis is a method for separating the most significant causes (the “vital few”) from the least significant ones (the “trivial many”). For most companies, there are about 10 to 20 of these critical behaviours, a typical list including, for example:
1. taking an unsafe position;
2. not paying attention;
3. using improper procedures;
4. slippery work surface; and
5. poor weather.

Observers are then trained on how to make positive observations regarding these behaviours and to provide constructive feedback to employees, which if done properly will improve the likelihood that these critical behaviours are performed safely. The observations are recorded, and the percentage of the observations which are done safely is tracked. As the “percent safe” increases, injuries tend to come down. Companies that have implemented BBS properly and stayed the course for at least three to five years, have seen impressive results: incidents and injuries decreased, and morale improved.

Many companies have successfully implemented a BBS process, but it is not easy to do. BBS has three main drawbacks: the time it takes to see significant results, the expense required to get it off the ground, and the potential conflict that may arise from observing at-risk behaviours which are contrary to rules and regulations.

With regard to time, BBS requires at least a three-year commitment, and not everyone has the patience to stay the course long enough to see results. One of the reasons BBS takes so long is that there are comparatively few people involved in the change process, other than during the observations.

Competent observers who are skilled at giving appropriate feedback are also critical to its success. Through rote observation and repetition, critical behaviours are eventually brought up to “habit strength,” which means that even if the employee is not thinking about the risk, the behaviour will be performed safely. Getting behaviours to habit strength through repetition takes time.

A typical BBS implementation has around 10 to 15 percent of the workforce trained to be observers. In most cases, each observer will make about one or two observations a week, which means that an average employee can expect to be observed about once every four to six weeks. The observations take around five to ten minutes. Being observed five to ten minutes per month is not enough to cause a dramatic difference in behaviour in a short period of time.

The second drawback of the traditional BBS process is the money required to get the process off the ground. Consultants cost money, and good consultants cost a lot of money. Consultants are often used because they have been through the process scores of times before. They know the mistakes that employers will be tempted to make, and know how to turn the naysayers into cheerleaders. They know how to keep the focus on the things that matter. Expensive trainers and consultants are therefore very much a necessity if you wish to implement an effective BBS program.

Finally, there is the potential conflict that can result if rule violations are observed and discipline is brought into the process. Even though everyone who works in the BBS field advocates that discipline should not be brought into the process on actual observations, many employees fear BBS will just become an extension of the current progressive discipline structure. Very few people will be interested in making observations if they are worried that what they observe will get someone in trouble, so observers may turn a blind eye to certain hazardous behaviours.

As noted above, another common tool in accident prevention is that of accident investigation. Accident investigations are usually performed by specially trained individuals, who follow basically the following steps:
1. gathering evidence from the scene of the accident, including:
   a. taking pictures or making sketches;
   b. noting environmental conditions;
   c. collecting samples;
   d. examining broken equipment; and
   e. interviewing witnesses and those involved;
2. analysing the evidence in an effort to determine how and why the accident occurred and what the causes were. Sometimes additional evidence must be gathered and considered to answer new questions which arise during the analysis; and
3. making recommendations on how such accidents might be avoided in the future. A typical investigation report offers the four following categories for recommendations:
   a. policy/procedure;
   b. training;
   C. equipment condition; or
   d. supervision.
      A number of flaws with this methodology can be identified.

To begin with, most accident/incident investigation methodologies tend to look at the injury or incident from an external perspective. In other words, a third party typically investigates the incident or injury instead of the person who was involved in the accident. In the case of a very serious injury or fatality, this makes perfect sense because the individual would simply not be in a position to perform the investigation. But in other cases where the individual was not seriously injured, it is still much more common for someone else to investigate it. The rationale is usually:
1. we want the investigation to be impartial, we want it to be fair; and
2. only highly trained and skilled individuals can perform a proper accident investigation.

Quite simply, third party accident investigators cannot understand what actually happened at the time of the accident, or what the thought processes of the individuals involved were at the time. As well, the generally accepted accident investigation forms tend to direct the investigation toward tangible causes which can be dealt with in an administrative manner, regardless of whether those were the actual causes of the accident.

The use of third party investigators, coupled with a restricted and incorrect investigation model, results in improper analysis of the causes and ineffective feedback. Thus, many accident investigation reports offer useless recommendations and actions performed, such as “reviewed safety procedures with worker”. This is about as effective as telling a child to “be more careful”.

There is therefore a need for a method and system which is more effective in reducing the frequency of accident occurrences, and the severity of the damages that result from these accidents. This design must be provided with consideration for the cost of implementing the system, the time required before seeing significant results, and being able to avoid possible conflicts associated with reporting on the improper activities of others.

### SUMMARY OF THE INVENTION

It is therefore an object of the invention to provide a novel method and system of reducing accident occurrences which obviates or mitigates at least one of the disadvantages of the prior art.

One aspect of the invention is broadly defined as a method of A method of reducing the frequency of industrial accidents comprising the steps of: determining the mental state of an individual at the time of an accident or close call; classifying the cause of the accident as being due to the individual being in one of four hazardous mental states; identifying the state-to-error risk pattern; and teaching the individual to effect critical error reduction techniques, to avoid future occurrences of accidents.

Another aspect of the invention is defined as a form for use in accident investigation comprising: a first field for entering a description of an accident; text identifying the four possible mental states of an individual involved in the accident; a second field for identifying the mental state of the individual; text identifying the four state-to-error risk patterns; and a third field for identifying the state-to-error risk pattern which resulted in the incident occurring; and text identifying critical error reduction techniques which might reduce the likelihood of the incident occurring again.

A further aspect of the invention is defined as a method of training individuals to avoid accidents, comprising the steps of: teaching the individual to: determine their own mental state at the time of an accident or close call; classify the cause of the accident as one of one of four hazardous mental states; identify the state-to-error risk pattern which caused the accident; and effect critical error reduction techniques, to avoid future occurrences of accidents.

### BRIEF DESCRIPTION OF THE DRAWINGS

These and other features of the invention will become more apparent from the following description in which reference is made to the appended drawings in which:

FIG. 1 presents a symbolic diagram depicting the three possible sources of unexpected occurrences;

FIG. 2 presents a symbolic diagram of an exemplary risk pyramid;

FIG. 3 presents a symbolic diagram depicting the state-to-error risk patterns which increase the likelihood of accidents occurring;

FIG. 4 presents an exemplary checklist which may be used for implementing the invention;

FIG. 5 presents a flow chart of a methodology for reducing the likelihood of accident occurrence in an embodiment of the invention; and

FIG. 6 presents an exemplary computer system for implementing the invention.

### DETAILED DESCRIPTION OF PREFERRED EMBODIMENTS OF THE INVENTION

The existing accident reduction techniques do not operate effectively for a number of reasons. To begin with, they do not use the correct causation model.

In order to have an incident you must have some form of hazardous energy and something unplanned or unexpected has to happen. In order to have an injury, you must have some hazardous energy, something unplanned or unexpected has to happen, and this hazardous energy has to come in contact with a person or the person has to contact it. The perspective or focus traditionally has been on the source of the hazardous energy and keeping that hazardous energy from contacting the person through engineering controls, rules, procedures and personal protective equipment. However, there are limits to what can be achieved with rules, procedures, personal protective equipment, and engineering controls.

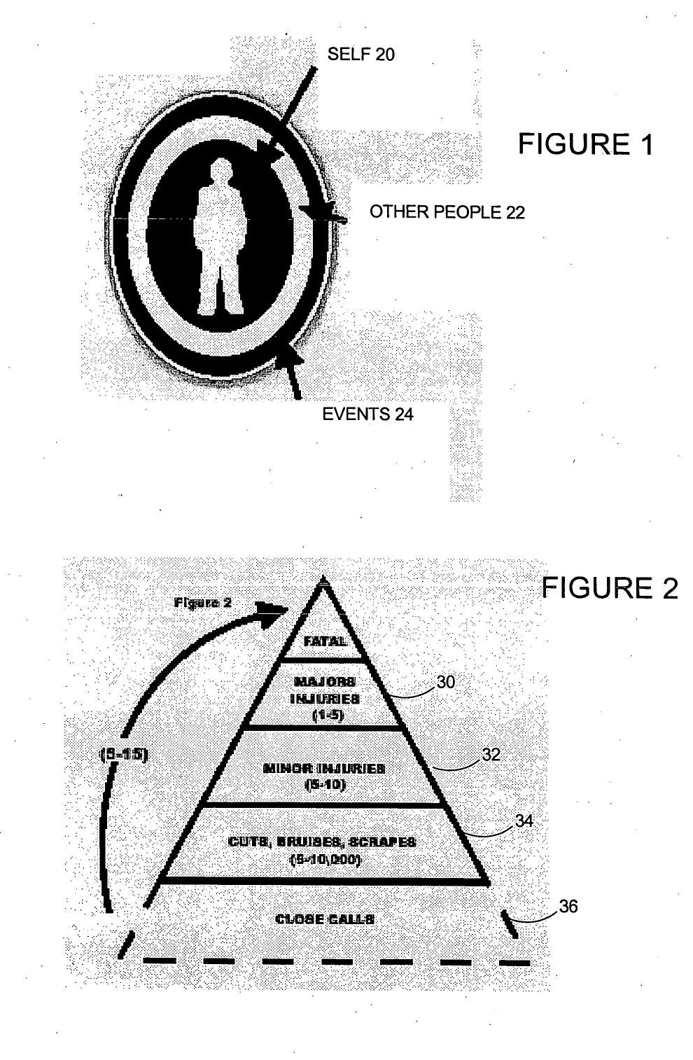

The invention considers the source of something unexpected happening. There are only three sources of the unexpected as shown in FIG. 1: either the individual does something unexpectedly 20, another individual does something unexpectedly 22, or the equipment or vehicle being operated does something unexpectedly 24. Accidents will be caused by one of those three, or a combination of them.

This is where problems arise when a third party performs the accident investigation. It is impossible for the external investigator to know exactly what was going on, or not going on, in the victim's mind at the moment or instant the accident occurred. So the investigator has to rely on what the injured person tells him. Since few people will be willing to incriminate themselves, they often do not tell the investigator that they were not thinking about what they were doing at that moment (for example). Even experienced accident investigators who have performed dozens and dozens of investigations may therefore have a distorted perspective on how people really do get injured, especially in terms of short term or acute injuries.

It is estimated by the National Safety Council that more than 90 percent of vehicle collisions or car wrecks are caused not by weather conditions, road conditions, or mechanical integrity of the car, but by drivers and driver error. The term “driver error” should not imply that it is the drivers' fault and that they are to blame. Clearly, drivers do not want to end up in the hospital as a result of not seeing a red light. Instead, “driver error” should refer to unintentional mistakes and poor habits. It would seem logical that in a typical unexpected occurrences model such as the one in FIG. 1, that the individual 20 is responsible for a very large proportion of the accidents.

This can be demonstrated to accident investigators by having them consider their own accidents—because they do know what they were thinking when they were in accidents. Asking accident investigators to consider the following, will demonstrate the importance of the individual behaviours:
1. ask the accident investigators to consider how many serious or major injuries they have experienced so far in their lifetime—how many broken bones, torn ligaments, third degree burns, etc.? Most people, if they are between 30 and 50, if they add it all up—on the job, off the job, driving their cars and sports (excluding contact sports) have experienced between one and five major injuries. This is shown in FIG. 2 as “major injuries” 30;
2. ask them to consider minor injuries 32—such as stitches, sprains and significant muscle strains. Again, most people if they are between 30 and 50 have experienced between five and ten of these types of injuries;
3. now if you drop down one more level on the risk pyramid, how many cuts, bruises and scrapes 34 have they experienced? Well, the most common answer is “lots”. But when you ask people if “lots” is hundreds or thousands; if they think about their first 20 years or if you get them to think of their own children—they quickly conclude that “lots” is thousands (with probably 3-5,000 they cannot even remember because they happened when they were under six years of age); and
4. the most significant category of all is at the bottom of the pyramid. How many close calls 36 have they experienced? How many times have they had to hit the brake quickly to avoid hitting another car, truck or pedestrian? How many times have they had to jerk the steering wheel to avoid hitting another vehicle?

How many times do they think they almost fell but managed to regain their balance without actually falling? Most people cannot even remember the number of times they have actually fallen, let alone “almost” fallen.

Thus, it is impossible for anyone to accurately count the number of close calls 36 they have had in total, but certainly the number is extremely large.

The typical personal risk pyramid of FIG. 2 shows that most individuals have experienced far more injuries and significant close calls than the number of injury/incident investigations that they have done or will ever do. Also, to a certain extent, the accident investigator can analyse this data more accurately because he knows what he or her was thinking about or not thinking about at that moment when the accident occurred.

The accident investigation process described in the Background usually only springs into action when there is a major accident causing work disruption, property damage or personal injury. It is not used when a minor accident or close call occurs, so clearly, it does not provide any constructive feedback in such cases. In contrast, the method of the invention can and should be applied to any and all accidents including the close calls, no matter how minor they seem to be.

Now, after building a personal risk pyramid, accident investigators should be asked “what was the source of the unexpected” in each of these injuries? They will typically determine that in over 90% of their own accidents, the “unexpected” factor that entered the equation was not the equipment 24 or another individual 22.

If, for example, a hundred accident investigators are asked to only think about their serious injuries (e.g. stitches or worse), and then asked how many of them had been “seriously hurt” in terms of a short-term or acute injury because the car being driven or the equipment being used broke, malfunctioned or did something unexpected, probably only two to five of them would answer in the affirmative. If the same group was asked “How many of you have been hurt because the “other guy” did something unexpectedly?”, about ten to fifteen would answer in the affirmative although most people will only have one example of such an incident. It can then be pointed out that the balance of the accidents, over 90% of the serious injuries, were caused by the individual's own actions.

However, if the analysis is repeated with the accident investigators considering cuts, bruises, bumps and scrapes 34, then over 99% of the acute injuries will be in the “self” area 20. In other words, with the exception of a very, very small percentage of cases, people hurt themselves. It is not the equipment 24 or another individual 22. We did something ourselves unexpectedly to cause the injury. And these numbers or percentages hold true, no matter whether you are on the job, off the job or driving your car.

The accident causation model of the invention goes even further though.

If a group of accident investigators is asked whether they have ever performed a “root cause” accident investigation, they will typically answer in the affirmative. If the same group is asked whether they have slammed a finger in a car door at some time (or had a similar accident), about half of them will typically answer in the affirmative.

If this group is then asked whether they did a root cause accident investigation following the slamming of their finger in the car door, almost invariably, they will respond in the negative. In fact, the typical reaction will be: “Why would I do that? It was just a stupid mistake.” The point can then be made that a huge proportion of accidents and close calls are “stupid mistakes”. Rather than causing such trivial incidents to be dismissed out of hand, the invention exploits even the smallest of incidents as an opportunity to train the individual to avoid other and possibly more damaging accidents. This will be described in greater detail hereinafter.

The causation models used in the prior art are fatally flawed in view of the model of the invention.

The BBS process never considers the state of mind of the individual at all—so clearly, it cannot address possible accidents when the state of the individual's mind changes from the usual, attentive state (it will be explained later that most accidents are caused when the individual enters a hazardous or high risk state of mind). Performing periodic observations as in the case of the BBS process, may address some hazardous states some of the time, but it cannot force an individual's habits to be modified so completely that they will still avoid errors when their mind enters one of these hazardous states.

The accident investigation model is also flawed, for at least the following reasons:
1. it only considers an incredibly small percentage of the occurrences in the risk pyramid, so it will take a long time to effect results. The method of the invention considers the vast number of minor accidents or close calls. As shown in the risk pyramid above, “close calls” are generally more common than any of the higher level occurrences;
2. accident investigation procedures typically draw attention away from the activity and thought process of the individual involved in the accident, by suggesting and encouraging the identification of external causes which can be addressed administratively. Accordingly, the actual cause of the accident is probably ignored or incorrectly identified in some 90% of the accidents; and
3. because the prior art techniques use third party investigators, they cannot be very successful in finding out what really occurred at the time of the accident.

Changing the focus of accident causation to the mental state of the victim is just the beginning though. The method and system of the invention includes an entire framework for identifying the actual behavioural cause of accidents and close calls, and providing tools to reduce the frequency of occurrence of such events.

The model recognizes the importance of the individual's state of mind and focuses on awareness of “critical behaviours”, or, if they are not performed safely, “critical errors”. The model of the invention contends that a “state-to-error” pattern exists, recognizing that before an error occurs, there is almost always at least one state (human factor) that predicates the error. It has been established that the following mental states of the victim predicate the majority of the errors which result in accidents:
1. rushing;
2. frustration;
3. fatigue; and/or
4. complacency.

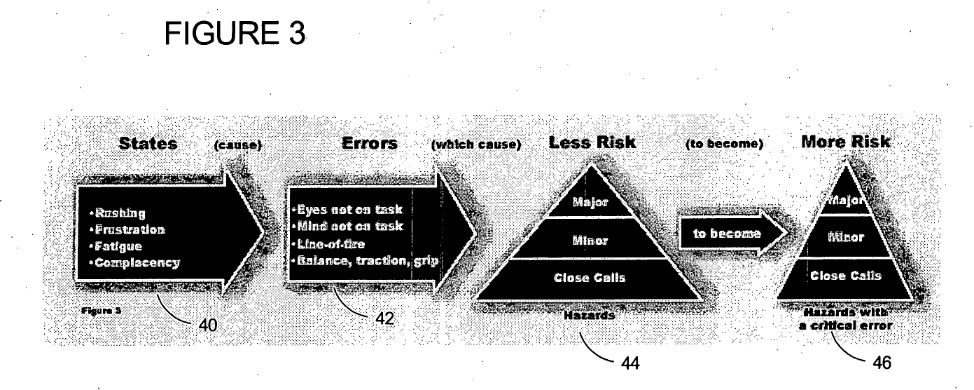

When individuals enter into one of these states of mind, they are far more likely to make one or more of these “critical errors”. These critical errors include the following:
1. eyes not on task;
2. mind not on task;
3. (moving into or being in) the line-of-fire; and
4. somehow losing your balance, traction or grip.
   This model is presented symbolically in FIG. 3. In short, if the individual is in one of the four hazardous mental states 40, this will dramatically increase the likelihood of one of the four critical errors 42 occurring. This, in turn, causes the risk of incidents in the accident pyramid to go from a level of low risk 44 to a level of high risk 46.

Identifying the states of mind which allow accidents to occur, and identifying the “state-to-error” pattern, puts one in a position to propose solutions. The invention proposes the following “critical error reduction techniques” or CERTs:
1. self-triggering on the hazardous states so you do not make the critical errors;
2. analysing close calls and small errors, learning from them to reduce the likelihood of major accidents occurring;
3. observing others for patterns which increase risk; and
4. working on improving your habits.

“Self-triggering” refers to the process of recognizing when you enter one of the dangerous states 40: rushing, frustration, fatigue, and/or complacency. Once employees have learned the mechanics of how accidents occur (i.e. that 90% of them are caused by the individual himself), they can learn to look for the four dangerous states.

If they can recognize when they are in a rush or frustrated or tired, and then think about the critical errors 42; i.e. eyes on task, mind on task, line-of-fire and balance, traction or grip; that is usually enough to keep from making one of those errors. In other words, employees are taught to “self-trigger on the state before you make the error”.

If the individual was not rushing or tired or frustrated when the accident occurred, they might have become complacent. Complacency can easily lead to the “mind not on task” critical error 42. Mind not on task can also lead to line-of-fire, eyes not on task and balance, traction or grip errors.

Complacency is not an easy thing to identify until after an accident or close call has occurred. However, it is easy enough to identify jobs or tasks where an individual is likely to become complacent (such as, while driving their car) and then get them to work on their habits. So even if their mind wanders they will still have their eyes on the road. Other habits like holding the handrail, testing your footing when getting out of your car, and looking before you move will reduce the risk of injury for other jobs or tasks when complacency might become a factor.

Employees can be taught to remember and check for these hazardous behavioural states 40 using standard techniques such as training sessions, practice exercises, posters, and checklists. Employees such be reminded to check for these hazardous states often enough that it becomes part of their routine.

The CERT of “analysing close calls” refers to the practice of teaching all individuals to perform the analysis of the invention for themselves, even when a very minor bump, bruise, cut or scrape occurs, or even when it was just a close call. This is in contrast to the standard accident investigation methodology, where only accidents with lost time injuries or property damage are considered. As noted above, there are far more “close calls” than any other kind of incident. Neglecting to analyse such situations misses a major opportunity for feedback which will help improve an individual's safety performance, preventing major accidents from occurring.

We have all been hurt thousands of times. If we could just learn a bit from each one, instead of writing it off as “just another stupid mistake”, we would all be a lot better off.

The CERT of “observing others for patterns which increase risk” simply means that individuals should observe the activities of others, and attempt to analyse the state-to-error risk patterns of those activities. Employees should be encouraged to get into a pattern of discussing such incidents with one another, and analysing these situations together. Identifying critical states in others can help you determine how to self-trigger on the states yourself, as well as learning when to caution others.

“Working on habits” simply refers to the traditional discipline of developing habits which allow you to avoid accidents, such as testing your footing before committing your full weight when getting out of your car. If an employee is in the habit of turning his eyes before turning his body, then even if he becomes complacent and his mind goes off task, he will still have a safe behaviour occurring automatically.

Habit forming techniques are encouraged and taught in the BBS process. The invention however, provides an additional level to the whole process because of the much stronger feedback mechanism it provides. Good habits are developed far faster with the method of the invention because feedback occurs far more frequently.

Reminders can be provided to the employees about the accident causation model of the invention, how to execute it, and to use it as often as possible; determining their state of mind at the time of the accident, identifying the “state-to-error” pattern, and finding a means of preventing a re-occurrence of the same pattern. Individuals can be reminded of this using standard techniques such as training sessions, practice exercises, posters, and checklists.

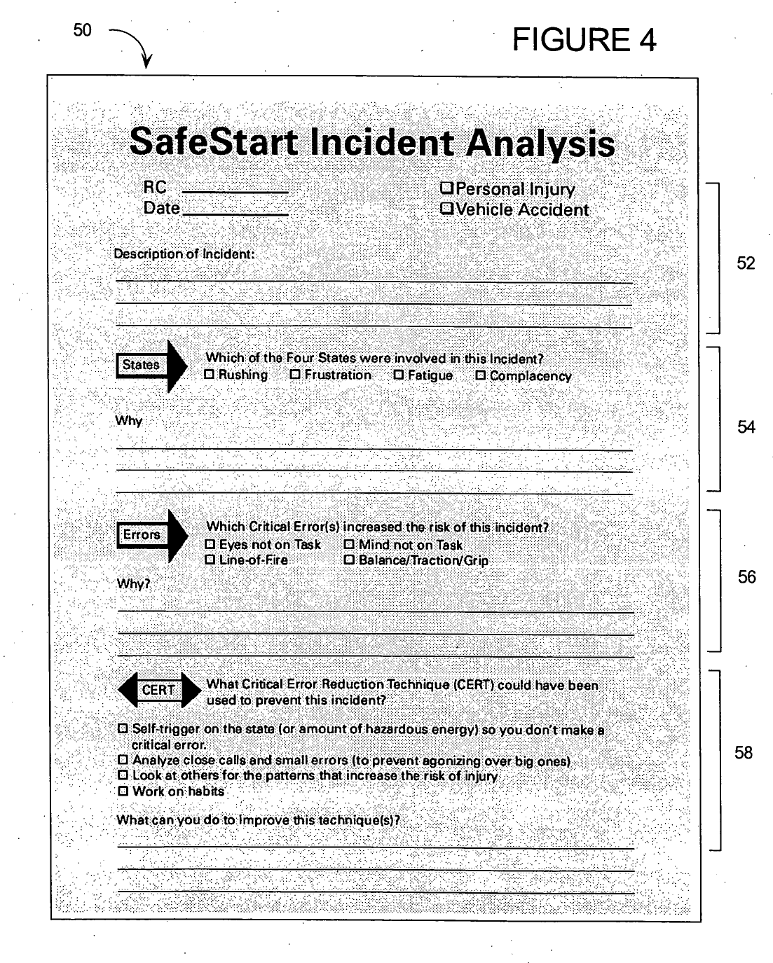

This model and methodology is embodied in the accident information form 50 presented in FIG. 4.

This form 50 has four sections:
1. an accident data section 52, with fields for entering a record number, date, and description of the incident, and boxes to identify whether the accident was a personal injury and whether a motor vehicle was involved. Other data could also be substituted for these,
2. a “states” section 54, which lists the four critical states noted above, and encourages the accident investigator to identify one of the causal states and to provide a written explanation;
3. an “errors” section 54, which lists the four critical errors noted above, and encourages the accident investigator to identify one of the errors and to provide a written explanation; and
4. a “critical error reduction techniques” (CERT) section 54, which prompts the accident investigator to consider the CERTs with the victim, providing him with the tools to prevent further accidents or close calls which follow the same pattern.

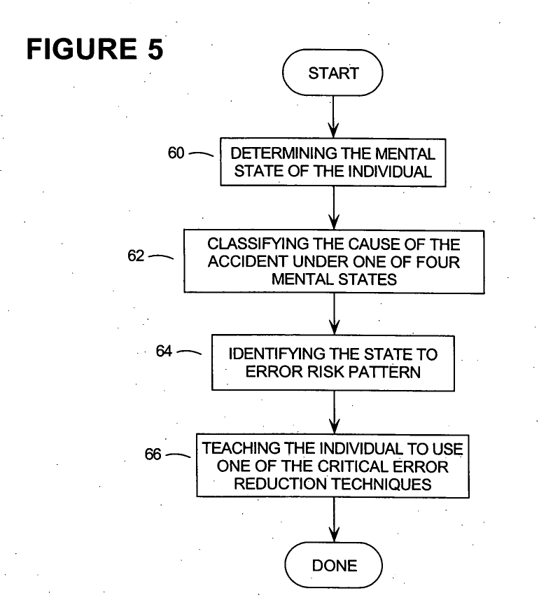

It follows from the above that the invention can be implemented using the methodology presented in the flow chart of FIG. 5. Specifically:
1. determining the mental state of the individual at the time the accident or close call occurred, at step 60;
2. classifying the cause of the accident to be the result of the individual entering into one of four critical mental states 40, at step 62;
3. identifying the state-to-error risk pattern that cause the critical error 42 to occur, at step 64; and
4. teaching the individual to effect critical error reduction techniques (CERTs), to avoid future occurrences of similar accidents or close calls, at step 66.

The method and system of the invention has met with considerable success in the world of health and safety training, providing major progress over known techniques. In short, the invention provides:
world-class incident rates;
a positive safety culture;
good morale;
high levels of involvement and participation; and
better off-the-job safety performance
   Options and Alternatives

While particular embodiments of the present invention have been shown and described, it is clear that changes and modifications may be made to such embodiments without departing from the true scope and spirit of the invention. For example, the invention could also be implemented in combination with other accident reduction systems and techniques, such as:
1. work place audits;
2. BBS;
3. accident analysis; and
4. “reality-base” videos.

The invention has been described with respect to certain examples and working environments. While health and safety programs are commonly implemented in heavy manufacturing, mining, pulp & paper, and the construction industry, clearly the invention could be applied to any working environment including the following:
1. health care industries, where the accidents often have an outward focus; i.e. they affect the patient;
2. driver's education programs, where the students generally have no knowledge of health and safety principles at all, and in fact, have little knowledge of the driving environment, possible hazards and warnings that they might receive while they begin driving; and
3. in contrast to item 2, the invention could be used to complement individuals who are highly trained with regard to health and safety, but for whom flawless execution is paramount. Airline pilots, search & rescue teams, military personnel, racing car drivers, chemical plant personnel, nuclear plant technicians, railroad operators and surgeons would be examples of such individuals.

The method steps of the invention may also be applied to a computer environment, for example as a software program operating on a personal computer. It could also be integrated into the firmware of a portable device such as a PDA (personal digital assistant), or a dedicated electronic accident investigation device. The principles of the invention similarly could be integrated into driver assistance systems in automobiles and/or aircraft. Automobile “telematics” systems which provide various passenger entertainment and driver assistance systems are becoming more and more common. The system could be passive, simply reminding the driver of the causation model and tools. As technology advances, the system could be more active, for example, providing the driver with feedback regarding the hazardous states.

The details of how such a system would be implemented would be clear to one skilled in the art from the teachings herein. The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

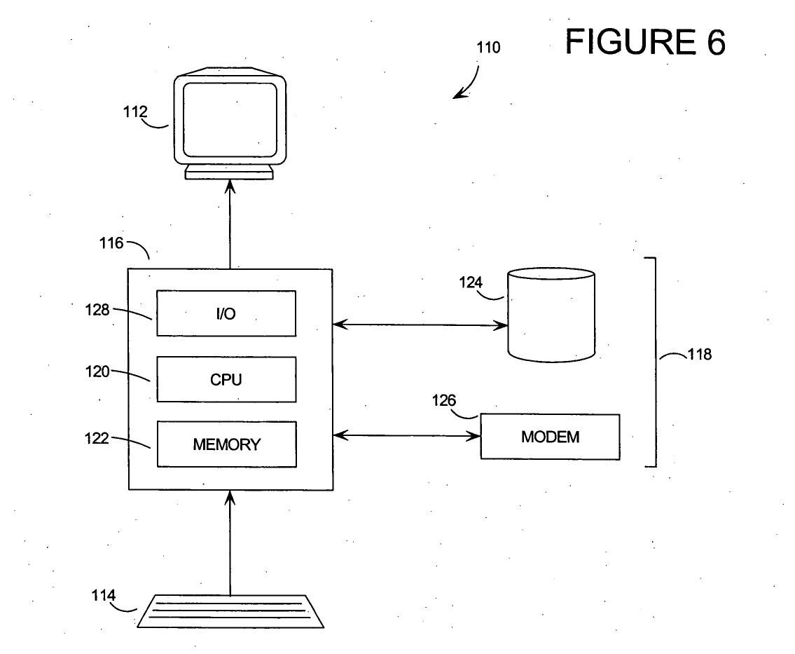

An exemplary computer system that could be used to implement the invention is presented in the block diagram of FIG. 6. This computer system 110 includes a display 112, keyboard 114, computer 116 and external devices 118.

The computer 116 may contain one or more processors or microprocessors, such as a central processing unit (CPU) 120. The CPU 120 performs arithmetic calculations and control functions to execute software stored in an internal memory 122, preferably random access memory (RAM) and/or read only memory (ROM), and possibly additional memory 124. The additional memory 124 may include, for example, mass memory storage, hard disk drives, floppy disk drives, magnetic tape drives, compact disk drives, program cartridges and cartridge interfaces such as those found in video game devices, removable memory chips such as EPROM or PROM, or similar storage media as known in the art. This additional memory 124 may be physically internal to the computer 116, or external as shown in FIG. 6.

The computer system 110 may also include other similar means for allowing computer programs or other instructions to be loaded. Such means can include, for example, a communications interface 126 which allows software and data to be transferred between the computer system 110 and external systems. Examples of communications interface 126 can include a modem, a network interface such as an Ethernet card, a serial or parallel communications port. Software and data transferred via communications interface 126 are in the form of signals which can be electronic, electromagnetic, optical or other signals capable of being received by communications interface 126.

Input and output to and from the computer 116 is administered by the input/output (I/O) interface 128. This I/O interface 128 administers control of the display 112, keyboard 114, external devices 118 and other such components of the computer system 110.

The invention is described in these terms for convenience purposes only. It would be clear to one skilled in the art that the invention may be applied to other computer or control systems 110.

1. A method of reducing the frequency of industrial accidents comprising the steps of:
determining the mental state of an individual at the time of an accident or close call;
classifying the cause of the accident as being due to the individual being in one of four hazardous mental states;
identifying the state-to-error risk pattern; and
teaching the individual to effect critical error reduction techniques, to avoid future occurrences of accidents.

2. The method of claim 1, wherein said step of teaching comprises a step selected from the group consisting of:
teaching the individual to “self trigger” on entering a hazardous state before making the error again in the future;
teaching the individual to analyse close calls and small errors, learning from them, to reduce the likelihood of major accidents occurring;
teaching the individual to observing others for patterns which increase risk; or
teaching the individual to work on improving their good habits.

3. The method of claim 1, wherein said step of classifying comprises a step selected from the group consisting of:
classifying the individual to be a mental state of “rushing”;
classifying the individual to be a mental state of “frustration”;
classifying the individual to be a mental state of “fatigue”; or
classifying the individual to be a mental state of “complacency”.

4. The method of claim 1, wherein said step of identifying comprises a step selected from the group consisting of:
identifying a critical behaviour of “eyes not on task”;
identifying a critical behaviour of “mind not on task”;
identifying a critical behaviour of “(moving into or being in) the line-of-fire”; or
identifying a critical behaviour of “somehow losing your balance, traction or grip”.

5. The method of claim 1, further comprising the step of:
teaching the individual to perform the analysis of claim 1 when they have smaller incidents.

6. The method of claim 1, further comprising the step of:
instructing the individual to look for state-to-error risk patterns in the actions of others.

7. A form for use in accident investigation comprising:
a first field for entering a description of an accident;
text identifying the four possible mental states of an individual involved in said accident;
a second field for identifying the mental state of said individual;
text identifying the four state-to-error risk patterns; and
a third field for identifying the state-to-error risk pattern which resulted in the incident occurring; and
text identifying critical error reduction techniques which might reduce the likelihood of the incident occurring again.

8. A method of training individuals to avoid accidents, comprising the steps of:
teaching said individual to:
determine their own mental state at the time of an accident or close call;
classify the cause of said accident as their being in one of four hazardous mental states;
identify the state-to-error risk pattern which caused said accident; and
effect critical error reduction techniques, to avoid future occurrences of accidents.
